(19) United States
(12) Patent Application Publication
(10) Pub. No.: US 2026/0163922 A1
(43) Pub. Date: Jun. 11, 2026

(54) COMMUNICATION SESSION RECORDING SYSTEM

(71) Applicant: Apple Inc., Cupertino, CA (US)

(72) Inventors: Kevin V. BENDER, Cupertino, CA (US); Akshatha NAGESH, Sunnyvale, CA (US); Daniel B. POLLACK, Cupertino, CA (US); Elina LUA MING, Cupertino, CA (US); Jae Woo CHANG, Los Altos Hills, CA (US); Jesse W. BUNCH, Menlo Park, CA (US); Karthick SANTHANAM, Campbell, CA (US); Nicolas WAGNER, Cupertino, CA (US); Ryan P. NIELSEN, Sunnyvale, CA (US); Sasanka T. VEMURI, San Ramon, CA (US); Shantini P. VYAS, Cupertino, CA (US)

(21) Appl. No.: 19/178,788

(22) Filed: Apr. 14, 2025

Related U.S. Application Data
(60) Provisional application No. 63/647,075, filed on May 13, 2024.
(60) Provisional application No. 63/657,953, filed on Jun. 9, 2024.

(51) Int. Cl. H04L 65/1046

(52) U.S. Cl. CPC H04L 65/1046

(57) ABSTRACT

The first electronic device may include a processor circuit configured to establish a communication session with a second electronic device, receive a request to record the communication session with the second electronic device, provide a notification to the second electronic device that the communication session will be recorded, verify that only the first and second electronic devices are participating in the communication session, and, after providing the notification, record the communication session.

### CROSS REFERENCE TO RELATED APPLICATIONS

This application claims the benefit of U.S. Provisional Application No. 63/647,075, entitled “Communication Session Recording System,” filed May 13, 2024, and U.S. Provisional Application No. 63/657,953, entitled “Communication Session Recording System,”filed Jun. 9, 2024, the entirety of which are incorporated herein by reference.

### TECHNICAL FIELD

The present description generally relates to communication sessions between electronic devices and, more particularly, to recording communication sessions between electronic devices.

### BACKGROUND

Users may interact with each other with their electronic devices by entering into a communication session with their respective devices. The communication session may be configured to exchange data including audio data and/or video data.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for implementing the subject technology, in accordance with one or more implementations.

FIG. 2 depicts an example electronic device that may implement the subject technology, in accordance with one or more implementations.

FIG. 3 depicts an example user interface on an example application implementing the subject technology, in accordance with one or more implementations.

FIG. 4 depicts a diagram of an exemplary flow of audio data from a first device to a second device, in accordance with one or more implementations.

FIG. 5 depicts an example user interface of a communication session transcript, in accordance with one or more implementations.

FIG. 6 depicts an example user interface of a communication session summary, in accordance with one or more implementations.

FIG. 7 depicts a flow diagram of an example process for communication session recording, in accordance with one or more implementations.

FIG. 8 depicts a flow diagram of an example process for communication session summarization, in accordance with one or more implementations.

FIG. 9A depicts an example electronic system with which aspects of the present disclosure may be implemented in accordance with one or more implementations.

FIG. 9B depicts an example method for making an application programming interface (API) call, in accordance with one or more implementations.

FIG. 9C depicts an example method for using an API response, in accordance with one or more implementations.

FIG. 9D depicts an example device for making an API call, in accordance with one or more implementations.

FIG. 9E depicts an example system for providing an API response, in accordance with one or more implementations.

FIG. 9F depicts a sequence diagram of the example method of FIG. 9B, in accordance with one or more implementations.

FIG. 9G depicts a sequence diagram of the example method of FIG. 9C, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pretrained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Electronic devices, such as smartphones, allow users to communicate with each other through modes such as voice and video. Users may want to record their communication sessions for later use. However, users may also want to be mindful of security and privacy considerations when recording a communication session. Users may want the recording to occur locally, without relying on third parties or external devices. Users may also want to be sure that appropriate disclosures are provided and/or consents are obtained before recording. Users may also want any data processing of the recording to also occur locally, without relying on third parties or external devices. Aspects of the subject technology address the foregoing considerations in a manner integrated with native device functionalities, thereby providing an intuitive, yet secure and privacy-preserving, user-friendly experience.

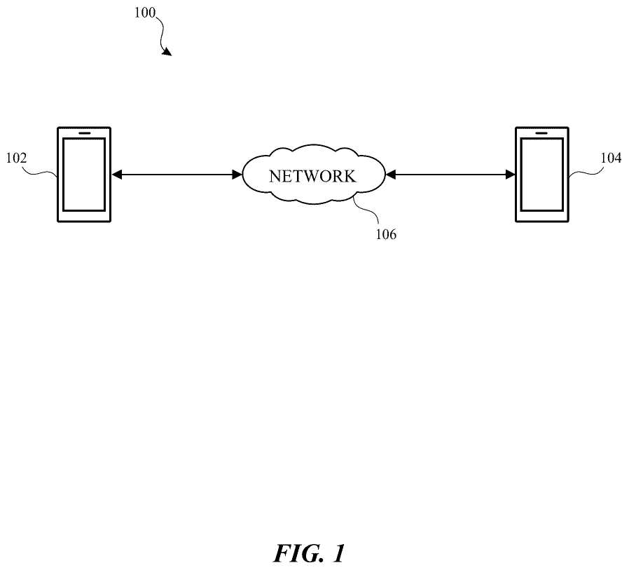

FIG. 1 illustrates an example network environment 100 for implementing the subject technology, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102 and an electronic device 104. The network 106 may communicatively (directly or indirectly) couple the electronic device 102 and the electronic device 104. In one or more implementations, the network 106 may be an interconnected network of devices that may include, or may be communicatively coupled to, the internet. In one or more implementations, the network 106 may be one or more cellular networks. For explanatory purposes, the network environment 100 is illustrated in FIG. 1 as including the electronic device 102 and the electronic device 104; however, the network environment 100 may include any number of electronic devices and/or any number of servers communicatively coupled to each other directly or via the network 106.

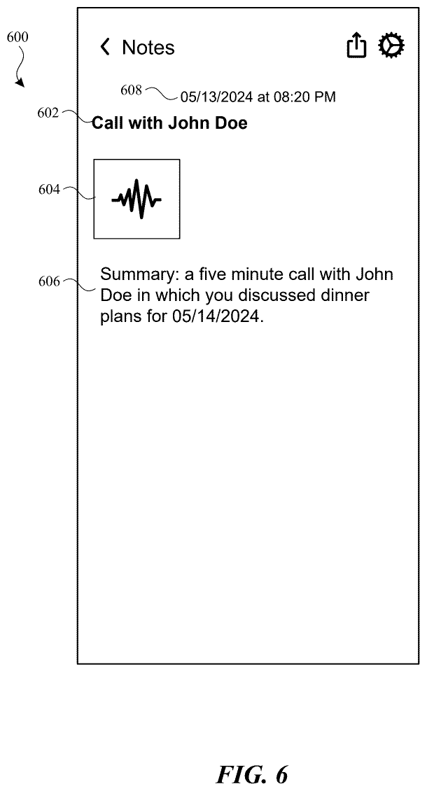

The electronic device 102 may be, for example, a wearable device (e.g., a watch, a band, and the like), a desktop computer, a portable computing device (e.g., a laptop computer, smartphone, tablet, and the like), a peripheral device (e.g., a digital camera, headphones, and the like), or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone. The electronic device 102 may be, and/or may include all or part of, the electronic system discussed below with respect to FIG. 6. In one or more implementations, the electronic device 102 may include a microphone and/or a camera.

The electronic device 104 may be a device similar to the electronic device 102. For example, the electronic device 104 may also be a smartphone. The electronic devices 102, 104 may include one or more applications for obtaining and/or exchanging user communication data (e.g., audio streams and/or video streams) over the network 106, such as with a corresponding application that is installed and accessible at another electronic device.

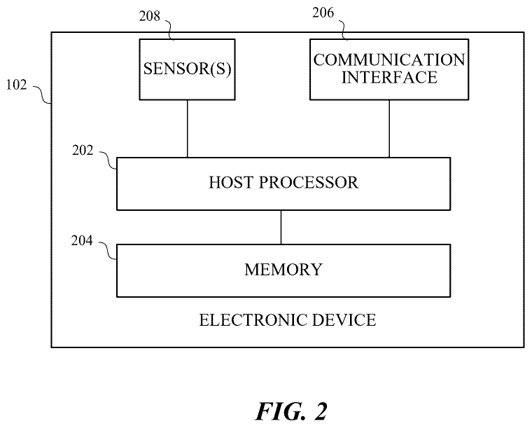

FIG. 2 illustrates an example electronic device 102 that may implement the subject technology, in accordance with one or more implementations. For explanatory purposes, the electronic device 102 is illustrated in FIG. 2. However, one or more of the components of the electronic device 102 may also be implemented by the other electronic devices 104 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 102 may include a processor 202, a memory 204, a communication interface 206, and one or more sensor(s) 208. The processor 202 may include suitable logic, circuitry, and/or code that enable processing data and/or controlling operations of the electronic device 102. In this regard, the processor 202 may be enabled to provide control signals to various other components of the electronic device 102. The processor 202 may also control transfers of data between various portions of the electronic device 102. Additionally, the processor 202 may enable implementation of an operating system or otherwise execute code to manage operations of the electronic device 102.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

The communication interface 206 may include suitable logic, circuitry, and/or code that enables wired or wireless communication, such as between any of the electronic devices 102, 104 over the network 106, and/or via peer-to-peer communications. The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

The sensor(s) 208 may include one or more microphones and/or cameras. The microphones may be used to facilitate the audio features of a communications session. For example, the microphones may obtain audio signals corresponding to the voice of a participant of a communications session. The cameras may be used to facilitate the video features of a communications session. For example, the cameras may obtain images or video of a participant of a communications session.

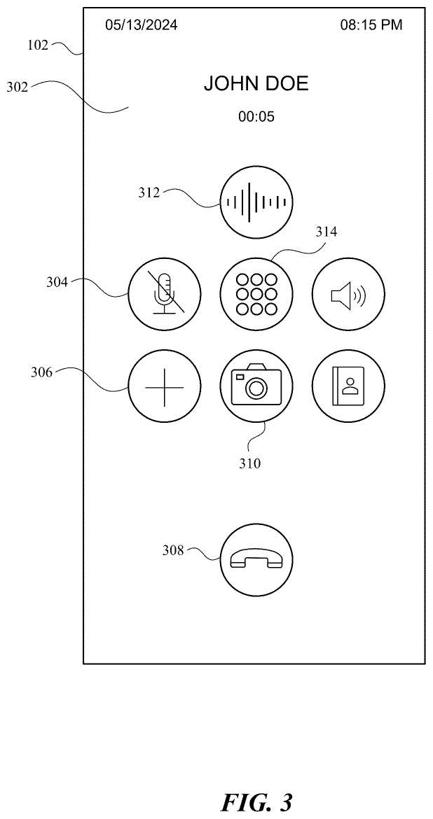

FIG. 3 depicts an example user interface 302 on an example application implementing the subject technology, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 102 may include one or more applications for establishing communication sessions, such as voice and/or video calls. In FIG. 3, the electronic device 102 is displaying a user interface 302 associated with an application that is used to make a voice call with “John Doe,” the user of electronic device 104. The user interface 302 may provide the user a variety of options for actions to take during the call. For instance, the user may end the call with element 308, turn the call into a video call with element 310, add another participant to the call with element 306, mute the microphone of the electronic device 102 with element 304, and record the call with element 312. For explanatory purposes, the user interface 302 is described with respect to the electronic device 102; however, the electronic device 104 may display a user interface that mirrors the functionality of the user interface 302.

To initiate the communication session recording feature during an active call, the user may interact (e.g., touch) with the element 312. Upon activating the recording, the user may be presented with an education screen informing the user about the implications of recording the call. For example, the education screen may inform the user that a pre-recorded message may be played on the call before recording begins, that the user may remain muted while the pre-recorded message is playing, and/or of the pre-determined location where the recording may be stored on the device. In one or more implementations, the user interface 302 may offer the user of the electronic device 102 (and/or similarly the user of the electronic device 104) a confirmation user interface element to confirm their intention to proceed with the recording. The confirmation may be provided verbally (e.g., the user says “continue”) and/or via user input into the user interface 302 (e.g., the user interacts with a visual element on the user interface 302 that says “continue”). In one or more implementations, the recording may begin after the notification without obtaining express consent from either user.

Upon activating the recording, a countdown may also or instead be triggered. The countdown may offer a brief moment before the actual recording commences. The countdown may be displayed on the user interface 302 and/or played to the user as audio output from the electronic device 102 and/or to the user of the electronic device 104.

Upon activating the recording, an audio disclosure may also or instead be triggered for alerting the parties to the communication session that a recording process is starting. The audio disclosure may be pre-recorded and may announce that the call is about to be recorded. The audio disclosure may be injected into the uplink and downlink data streams of the communication session such that the audio disclosure may be heard by both participants to the communication session. In some embodiments, the disclosure may also or instead be a visual indicator that may be provided on the user interface 302 and similarly on a user interface of the electronic device 104. If the electronic device 104 stays on the communication session after the recording, the electronic device 104 may be considered to have consented to the recording. Additionally or alternatively, prior to recording the communication session, the electronic device 102 may receive from the electronic device 104 an explicit indication of consent to being recorded (e.g., the user of the electronic device 104 verbally consents).

The recording process itself may be seamless and unobtrusive, capturing inbound and/or outbound data of the communication session. The recording process may be performed by the electronic device 102. The recorded communication session data (the “recording”) may be stored in a pre-determined location on the electronic device 102 (e.g., memory 204).

The user has the flexibility to end the recording by manually interacting with element 312 in the user interface 302 or by simply hanging up (e.g., interacting with element 308), concluding the call in the traditional manner. Additionally, the recording may automatically cease if the call dynamics change, such as when a third party joins the communication session (e.g., by interacting with element 306 to expand the communication session), making the call ineligible for recording.

Like the disclosure message provided before the recording process, in some embodiments, after the recording has concluded (e.g., the user has interacted with element 312 to end the recording), a post-recording disclosure message may be injected into the communication session to notify the participant of the communication session that the recording has concluded. The post-recording disclosure message may be similar in content and/or form to the pre-recording disclosure message. For example, the post-recording disclosure message may be a pre-determined audio and/or visual notification.

In some embodiments, a transcript generation process of the electronic device 102 occurs concurrently with and/or subsequent to the recording process.

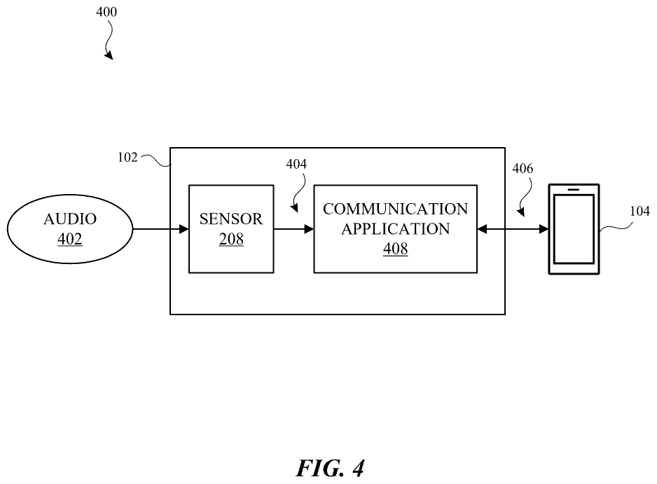

FIG. 4 depicts a diagram of an exemplary flow 400 of audio data from electronic device 102 to electronic device 104, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

During the recording process described above with respect to FIG. 3, audio 402 from the user may be captured by a sensor 208 (e.g., microphone) of the electronic device 102. The audio 402 may be converted into electronic signals and provided to another component of the electronic device 102, such as the communication application 408, which may transmit the audio 402 to another participant of the communication session, such as the electronic device 104.

Throughout the recording process, the user's chosen mute settings (e.g., as indicated by element 304) may be respected. However, one or more audio disclosures may be injected into the outbound communication data without interfering with the user's mute preferences. The communication session recording feature may incorporate one or more muting mechanisms that respect the privacy and preferences of both parties while also complying with legal requirements for disclosing the recording of the communication session and/or obtaining party consent via disclosure of the recording of the communication session.

The electronic device 102 may include at least two types of muting: a device mute and a call transport mute. A device mute may be a setting controlled by the user (e.g., via element 304) at the application layer in the user interface 302 and may control whether the sensor 208 (e.g., microphone) of the electronic device 102 is active or muted. The device mute may directly impact the data stream sent from the electronic device 102, allowing the user to choose when to transmit their audio 402 during the communication session. For example, the device mute may prevent the transfer of the audio 402 from the sensor 208 to the communication application 408, as represented by line 404. A call transport mute may refer to the ability to mute or unmute the call transport layer (e.g., a system layer below the application layer) independently of the device mute setting. By controlling the call transport, the electronic device 102 can inject audio disclosures into the output data without interfering with the user's chosen device mute state. For example, the call transport mute may prevent the transfer of the audio 402 from the communication application 408 to the electronic device 104, as represented by line 406.

When the recording process is initiated, the electronic device 102 may automatically unmute the call transport layer (e.g., if the user has the call muted) to inject an audio disclosure, informing both parties of the impending recording process. Simultaneously, the device mute setting (e.g., represented by element 304) may remain unchanged so that the user's preferred device mute setting is respected. Throughout the communication session, the user interface 302 may present a single, intuitive mute button (e.g., element 304), reflecting the user's chosen device mute state and allowing the user to toggle their sensor 208 activation preference without affecting the underlying call transport mute setting. As a result, the user can manage their audio 402 input while knowing that recording disclosures can still be injected into the call.

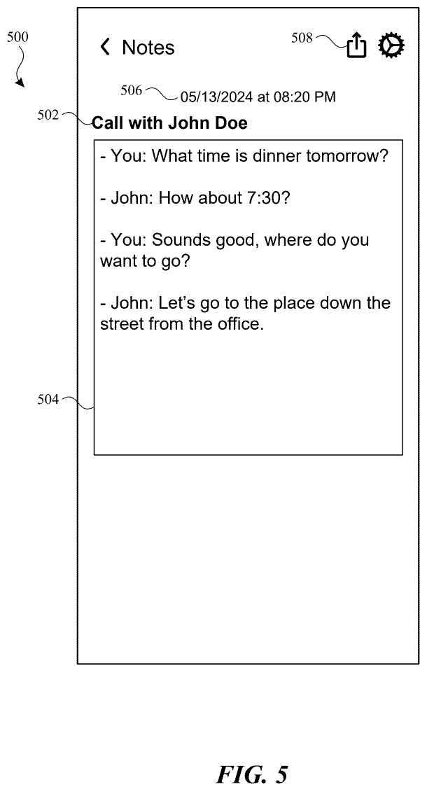

FIG. 5 depicts an example user interface 500 of a communication session transcript 502, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As discussed above with respect to FIG. 3, a transcript generation process of the electronic device 102 may occur concurrently with and/or subsequent to the recording process. The transcript generation process may employ real-time speech-to-text conversion (e.g., using an AI process or a generative AI process). Real-time speech-to-text conversion, also known as automatic speech recognition (ASR), may involve acoustic and/or language machine learning (ML) models. Acoustic models may be responsible for analyzing the acoustic patterns and/or characteristics of the spoken words. Acoustic models may employ algorithms, such as hidden Markov models (HMMs) or deep neural networks (DNNs), to identify and classify the unique acoustic features of each word. By training on vast amounts of audio data, the acoustic models may learn to recognize distinct sounds, enabling the models to map the incoming audio stream to their corresponding textual representations. On the other hand, language models may be used to understand the context and/or structure of the spoken language. Language models may utilize statistical or neural network-based approaches, such as n-gram language models or recurrent neural networks (RNNs), to predict the most probable sequence of words based on the context. During a communication session, an incoming audio stream may be segmented into small frames, such as 10 to 25 milliseconds. The frames may then be processed using signal processing techniques, such as noise reduction and feature extraction, to enhance the clarity and quality of the audio input. Subsequently, the acoustic model may analyze the frames, employing algorithms like mel-frequency cepstral coefficients (MFCCs) and/or deep learning-based feature extraction methods, to capture the unique characteristics of each word. The extracted features may then be passed through the acoustic model, which may output a likelihood distribution over a set of predefined speech units, such as subword units. Simultaneously, the language model may consider the contextual information, predicting the most probable sequence of words based on grammatical rules and the semantic flow of the conversation.

The transcript may then be formatted with the addition of speaker labels. Text corresponding to outbound audio may be labeled as the user of the electronic device 102, text corresponding to inbound audio may be labeled as the user of the electronic device 104. Contact information, phone numbers, or email addresses associated with the participants may be utilized to label the transcript, providing clear identification of who spoke which portion of the conversation.

Upon concluding the recording process, the recording and/or its corresponding transcript may be saved to the electronic device 102 and/or seamlessly integrated into another application (“app”), such as a notes app including a user interface 500, to create a dedicated space for post-call review. For example, after the call with the electronic device 104 has concluded, the electronic device 102 may create a new note in the notes app with a name 502 representing the communication session and the parties involved and with a timestamp 506 corresponding to the communication session. The transcript 504 of the communication session may be inserted into the new note. In some embodiments, the recording of the communication may also be stored in association with the new note.

In some embodiments, when the transcript 504 and the recording of the communication session are in the new note, the user can also access further details, including the option to play back the recording and/or delve into a detailed view that may showcase a waveform representation of the recording alongside a display of the transcript that scrolls such that the transcript is synchronized with the recording playback, allowing users to follow along and quickly navigate to specific portions of the conversation.

In some embodiments, the new note may be shared (e.g., via graphical element 508) to one or more other users (e.g., electronic device 104). This may allow for collaborative viewing and/or modification of the contents of the new note, such as the transcript 504 and/or the recording of the communication session.

FIG. 6 depicts an example user interface 600 of a communication session summary, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In addition to or instead of the transcript 504, the user interface 600 of a new note may include the recording 604 and/or a summary 606 of the communication session, as well as the title 602 and timestamp 608 based on the communication session. The recording 604 may be a file stored on the electronic device including the data (e.g., audio and/or video) from the communication session.

The summary 606 may be a brief textual description of the communication session. The summary 606 may be generated automatically using on-device machine learning (ML) models and/or server-based processing (e.g., using an AI process or a generative AI process). In some implementations, the summary 606 may be generative text and/or audio. After the communication session concludes, a summary may be automatically created using an on-device ML model. The ML model employed for this task may be a natural language processing (NLP) algorithm, specifically trained for summary generation based on, for example, the transcript of the communication session. The ML model may process the transcribed text, analyzing its structure, identifying key phrases, and/or extracting salient information. Techniques such as keyword extraction, topic modeling, and/or transformer-based models, could be utilized to generate a summary, providing the user with an overview of the content of the communication session. Additionally or alternatively, the user may be offered an option to request a more comprehensive summary by leveraging a server-based ML model. If the user opts for an extended summary, the recording and/or the transcript may be securely transmitted to a trusted remote server. The server may then apply more computationally intensive ML models, which may utilize increased processing power and/or access to larger datasets for improved context understanding. The server-based ML model could employ techniques such as long-form text generation using generative pretrained transformer models and/or utilize domain-specific knowledge bases to provide an in-depth analysis of the communication session, such as any underlying themes, sentiments, or action items discussed during the conversation.

In some embodiments, if the user of the electronic device 104 does not consent to being recorded yet remains on the communication session after the recording disclosure has been played, the electronic device 102 may perform a transcript generation process, but not a recording process, on the communication session data live as the communication session is occurring. After the communication session, the electronic device 102 may generate the summary 606 of the transcript and discard the transcript of the communication session to respect the privacy of the electronic device 104.

In some embodiments, if the user of the electronic device 104 does not consent to being recorded yet remains on the communication session after the recording disclosure has been played, the electronic device 102 may perform a recording process and/or transcript generation process only on the consenting parties.

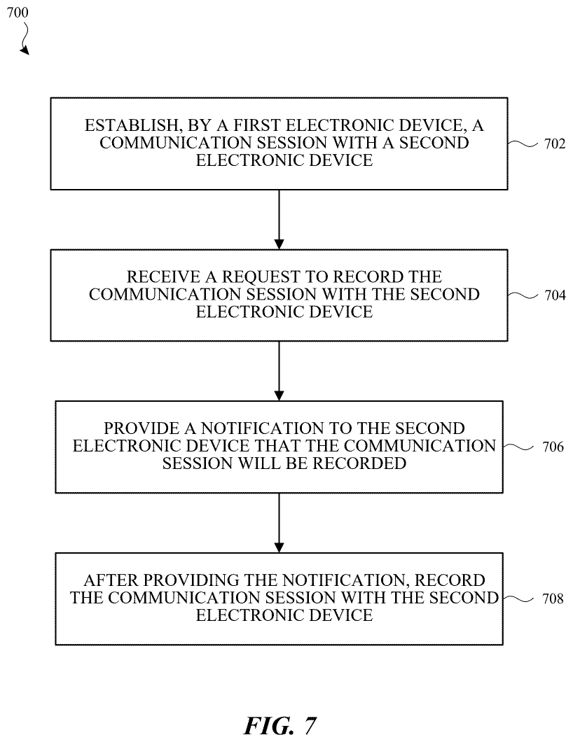

FIG. 7 depicts a flow diagram of an example process 700 for communication session recording, in accordance with one or more implementations. For explanatory purposes, the process 700 is primarily described herein with reference to the electronic device 102 and the electronic device 104 of FIG. 1. However, the process 700 is not limited to such devices, and one or more blocks of the process 700 may be performed by one or more other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, the electronic device 102 may establish a communication session with the electronic device 104. The communication session may be an exchange of audio and/or video data with at least the electronic device 104. For example, the user may open a phone application (e.g., communication application 408 having a user interface 302) on the electronic device 102 and call the electronic device 104.

At block 704, the electronic device 102 may receive a request to record the communication session. The request to record may be received via a user input. The user input may be a touch input on a display of the electronic device 102. For example, the user may interact with a user interface element (e.g., element 312) of a communication application (e.g., communication application 408). The user input may also or instead be a verbal command from the user. For example, the user may say “start recording,” which may be audio 402 captured by a sensor 208 (e.g., microphone) of the electronic device 102.

At block 706, in response to the request, the electronic device 102 may provide a notification to the electronic device 104 that the communication session will be recorded. The notification may be an audio notification and/or a visual notification. For example, pre-recorded audio may be played on the communication session to the participants saying, “this call will be recorded.”

The call application may be running on an application layer of the electronic device and a device mute controlled by the user (e.g., via element 304 on the user interface 302) may be at the application layer. The electronic device 102 may also have a system layer operating at a lower level than the application layer, and the system layer may include a call transport mute. In some embodiments, if the user has muted the call (e.g., via element 304), the electronic device 102 may unmute its call transport and stream an audio notification through the communication session to notify participants about the recording process. This way, the user may still be muted (and the element 304 remain unchanged) while the electronic device 102 may be unmuted and stream the audio notification to the other participant of the communication session. After the audio notification is streamed through the communication session, the electronic device 102 may return to a muted state.

At block 708, after the notification is provided, the electronic device 102 may record the communication session with the electronic device 104. The recording process may be ended manually by ending the recording (e.g., interacting with element 312) or ending the call (e.g., interacting with element 308). The recording process may also be ended if another participant joins the communication session (e.g., the user interacts with element 306 or the electronic device 102 detects that another participant has joined).

In some embodiments, prior to recording the communication session, the electronic device 102 may verify that only the electronic devices 102, 104 are participating in the communication session.

In some embodiments, prior to recording the communication session, the electronic device 102 may receive from the electronic device 104 an indication of consent to the recording. The indication may be in audio form, such as in dual-tone multi-frequency signaling (DTMF tones) (e.g., the user may press 1 on a number pad interface that the user may launch with element 314) or verbally (e.g., “I am okay with recording”). The indication may also or instead be in video form, such as the user nodding in approval.

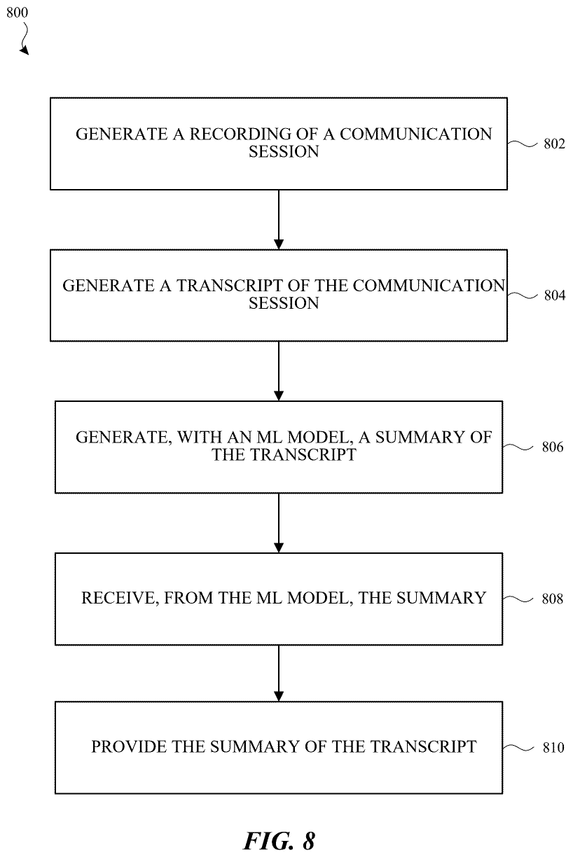

FIG. 8 depicts a flow diagram of an example process 800 for communication session summarization, in accordance with one or more implementations. For explanatory purposes, the process 800 is primarily described herein with reference to the electronic device 102 and the electronic device 104 of FIG. 1. However, the process 800 is not limited to such devices, and one or more blocks of the process 800 may be performed by one or more other suitable devices. Further, for explanatory purposes, the blocks of the process 800 are described herein as occurring sequentially or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, the electronic device 102 may generate a recording of a communication session between the electronic device 102 and the electronic device 104. The recording may include the inbound and/or outbound communication session data (e.g., audio and/or video data to and/or from the electronic device 102).

At block 804, the electronic device 102 may generate a transcript of the communication session. The transcript may be generated in real-time as the communication session data is received by the electronic device 102 such that the communication session may be transcribed without recording the communication session. In some embodiments, the transcript may be generated based on the recording of the communication session. The electronic device 102 may utilize local machine learning-based speech recognition models to transcribe audio from the communication session into text. In some embodiments, a user of the electronic device 102 may elect to use a remote machine learning model for a more accurate transcription.

At block 806, the electronic device 102 may generate a summary of the transcript of the communication session. Simultaneous and/or subsequent to block 804, a summary may be automatically generated using a local ML model, specifically trained for summary generation based on the transcript of the communication session and stored on the electronic device 102. Additionally or alternatively, the user may be offered an option to request a more comprehensive summary by leveraging a server-based ML model. If the user opts for an extended summary, the recording and/or the transcript may be securely transmitted to a trusted remote server by the electronic device 102.

At block 808, the electronic device 102 receives the summary output by a local and/or remote ML model. The summary, transcript, and/or recording of the communication session may be stored on the electronic device 102. In some embodiments, if a party to the communication session did not approve of the recording process, and thus a recording was not generated, the summary may be generated based on the transcript and may be stored on the electronic device 102, while the transcript may be discarded.

At block 810, the electronic device 102 may provide the summary to another application on the electronic device 102. The communication session may be facilitated by a first application running on the electronic device 102. The first application may perform, or direct another process to perform, the recording, transcription, and/or summarization tasks. The resulting summary may be provided to a second application on the electronic device 102, such as a notes application described above with respect to FIGS. 5-6. In some embodiments, the transcript and/or recording may also or instead be provided to the second application.

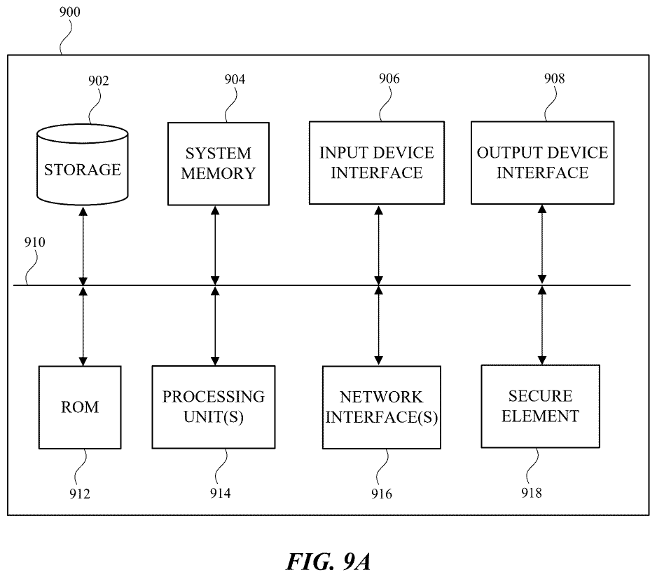

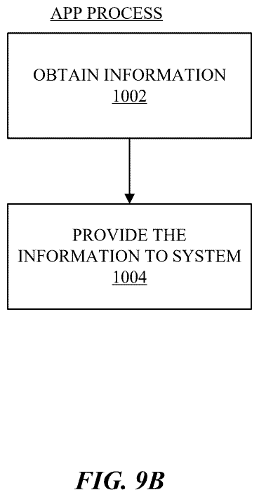

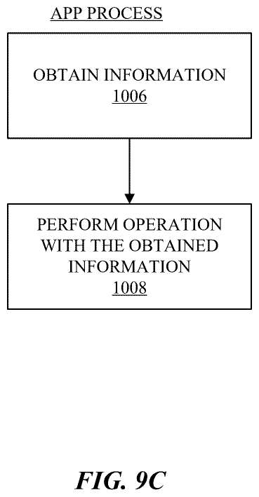

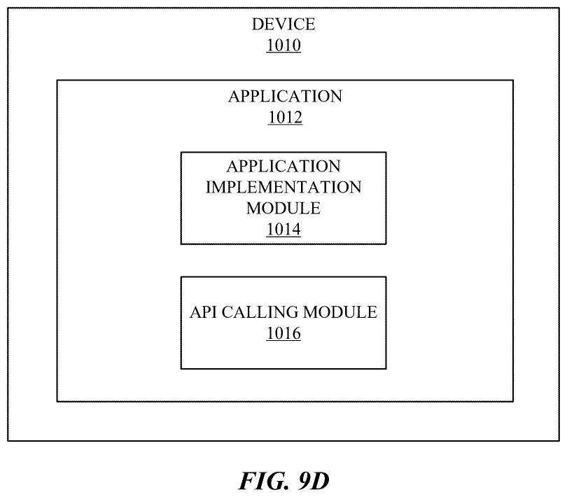

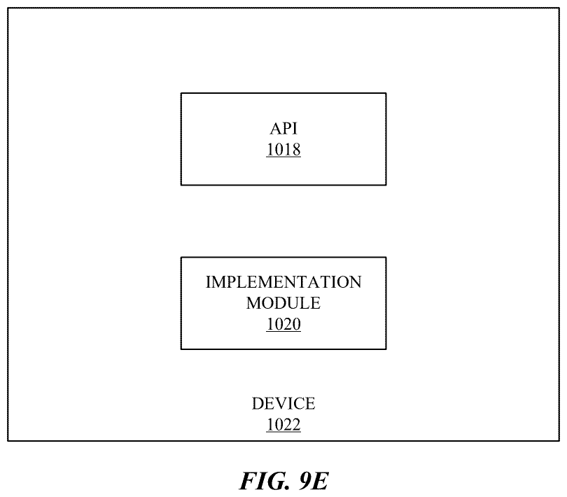

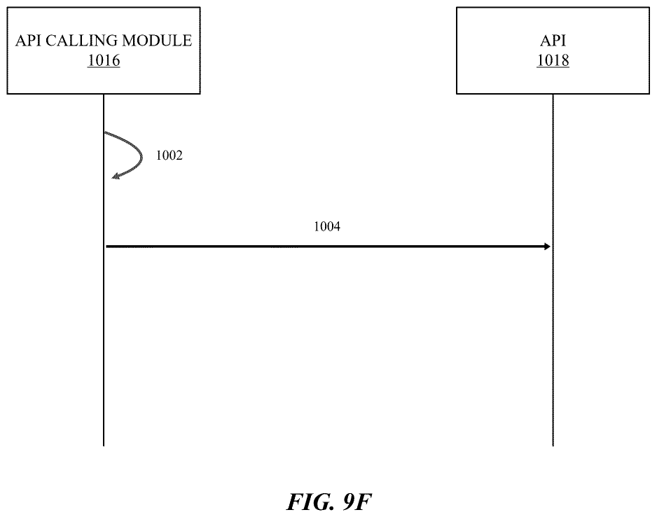

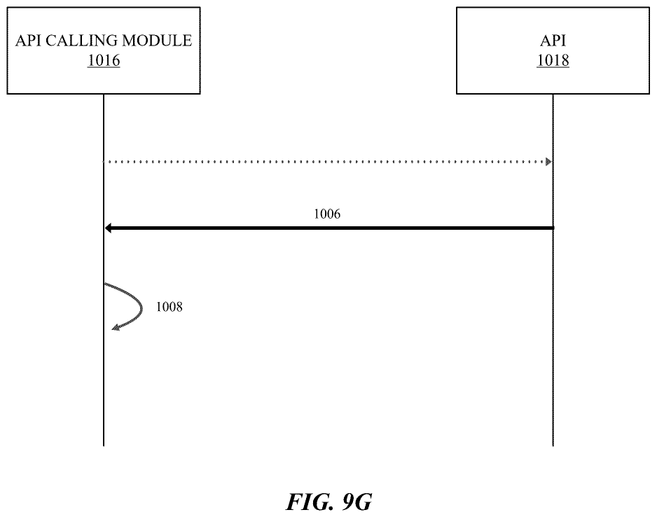

FIG. 9A depicts an example electronic system 900 with which aspects of the present disclosure may be implemented, in accordance with one or more implementations. The electronic system 900 can be, and/or can be a part of, any electronic device for generating the features and processes described in reference to FIGS. 1-8, including but not limited to a laptop computer, tablet computer, smartphone, and wearable device (e.g., smartwatch, fitness band). The electronic system 900 may include various types of computer-readable media and interfaces for various other types of computer-readable media. The electronic system 900 includes a persistent storage device 902, a system memory 904 (and/or buffer), an input device interface 906, an output device interface 908, a bus 910, a ROM 912, one or more processing unit(s) 914, one or more network interface(s) 916, a secure element 918, and/or subsets and variations thereof.

The bus 910 collectively represents all system, peripheral, and chipset buses that communicatively connect the numerous internal devices of the electronic system 900. In one or more implementations, the bus 910 communicatively connects the one or more processing unit(s) 914 with the ROM 912, the system memory 904, and the persistent storage device 902. From these various memory units, the one or more processing unit(s) 914 retrieves instructions to execute and data to process in order to execute the processes of the subject disclosure. The one or more processing unit(s) 914 can be a single processor or a multi-core processor in different implementations.

The ROM 912 stores static data and instructions that are needed by the one or more processing unit(s) 914 and other modules of the electronic system 900. The persistent storage device 902, on the other hand, may be a read-and-write memory device. The persistent storage device 902 may be a non-volatile memory unit that stores instructions and data even when the electronic system 900 is off. In one or more implementations, a mass-storage device (such as a magnetic or optical disk and its corresponding disk drive) may be used as the persistent storage device 902.

In one or more implementations, a removable storage device (such as a floppy disk, flash drive, and its corresponding disk drive) may be used as the persistent storage device 902. Like the persistent storage device 902, the system memory 904 may be a read-and-write memory device. However, unlike the persistent storage device 902, the system memory 904 may be a volatile read-and-write memory, such as RAM. The system memory 904 may store any of the instructions and data that one or more processing unit(s) 914 may need at runtime. In one or more implementations, the processes of the subject disclosure are stored in the system memory 904, the persistent storage device 902, and/or the ROM 912. From these various memory units, the one or more processing unit(s) 914 retrieves instructions to execute and data to process in order to execute the processes of one or more implementations.

The bus 910 also connects to the input device interfaces 906 and output device interfaces 908. The input device interface 906 enables a user to communicate information and select commands to the electronic system 900. Input devices that may be used with the input device interface 906 may include, for example, alphanumeric keyboards, touch screens, and pointing devices. The output device interface 908 may enable the electronic system 900 to communicate information to users. For example, the output device interface 908 may provide the display of images generated by electronic system 900. Output devices that may be used with the output device interface 908 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 910 also connects to secure element 918. The secure element 918 may include hardware and/or software that provides secure storage and management of sensitive information. The secure element 918 may be isolated from the processing unit 914 and operating system, making it more difficult for unauthorized access. The secure element 918 may be used for secure transactions and identification, such as in payment cards/credentials and digital passes. The secure element 918 may store sensitive information, such as cryptographic keys, and may protect the sensitive information (e.g., with cryptographic algorithms and access controls).

Finally, as shown in FIG. 9A, the bus 910 also couples the electronic system 900 to one or more networks and/or to one or more network nodes through the one or more network interface(s) 916. In this manner, the electronic system 900 can be a part of a network of computers (such as a local area network, a wide area network, an intranet, or a network of networks, such as the internet). Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 1012) that, when executed by one or more processing units, control an electronic device (e.g., device 1010) to perform the method of FIG. 9B, the method of FIG. 9C, and/or one or more other processes and/or methods described herein.

It should be recognized that application 1012 (shown in FIG. 9D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1012 is an application that is pre-installed on device 1010 at purchase (e.g., a first party application). In other embodiments, application 1012 is an application that is provided to device 1010 via an operating system update file (e.g., a first party application or a second party application). In some embodiments, application 1012 is an application that is provided via an application store. In some embodiments, the application store can be an application store that is pre-installed on device 1010 at purchase (e.g., a first party application store). In some embodiments, the application store is a third-party application store (e.g., an application store that is provided by another application store, downloaded via a network, and/or read from a storage device).

Referring to FIG. 9B and FIG. 9F, application 1012 obtains information (e.g., 1002). In some embodiments, at 1002, information is obtained from at least one hardware component of the device 1010. In some embodiments, at 1002, information is obtained from at least one software module (e.g., set of instructions) of the device 1010. In some embodiments, at 1002, information is obtained from at least one hardware component external to the device 1010 (e.g., a peripheral device, an accessory device, and/or a server). In some embodiments, the information obtained at 1002 includes positional information, time information, notification information, user information, environment information, electronic device state information, weather information, media information, historical information, event information, hardware information, and/or motion information. In some embodiments, in response to and/or after obtaining the information at 1002, application 1012 provides the information to a system (e.g., 1004).

In some embodiments, the system (e.g., 1022 shown in FIG. 9E) is an operating system hosted on the device 1010. In some embodiments, the system (e.g., 1022 shown in FIG. 9E) is an external device (e.g., a server, a peripheral device, an accessory, and/or a personal computing device) that includes an operating system.

Referring to FIG. 9C and FIG. 9G, application 1012 obtains information (e.g., 1006). In some embodiments, the information obtained at 1006 includes positional information, time information, notification information, user information, environment information electronic device state information, weather information, media information, historical information, event information, hardware information and/or motion information. In response to and/or after obtaining the information at 1006, application 1012 performs an operation with the information (e.g., 1008). In some embodiments, the operation performed at 1008 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1022 based on the information.

In some embodiments, one or more steps of the method of FIG. 9B and/or the method of FIG. 9C is performed in response to a trigger. In some embodiments, the trigger includes detection of an event, a notification received from system 1022, a user input, and/or a response to a call to an API provided by system 1022.

In some embodiments, the instructions of application 1012, when executed, control device 1010 to perform the method of FIG. 9B and/or the method of FIG. 9C by calling an application programming interface (API) (e.g., API 1018) provided by system 1022. In some embodiments, application 1012 performs at least a portion of the method of FIG. 9B and/or the method of FIG. 9C without calling API 1018.

In some embodiments, one or more steps of the method of FIG. 9B and/or the method of FIG. 9C includes calling an API (e.g., API 1018) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 9D, device 1010 is illustrated. In some embodiments, device 1010 is a personal computing device, a smart phone, a smart watch, a fitness tracker, a head mounted display (HMD) device, a media device, a communal device, a speaker, a television, and/or a tablet. Device 1010 includes application 1012 and an operating system (not shown) (e.g., system 1022 shown in FIG. 9E). Application 1012 includes application implementation instructions 1014 and API calling instructions 1016. System 1022 includes API 1018 and implementation instructions 1020. It should be recognized that device 1010, application 1012, and/or system 1022 can include more, fewer, and/or different components than illustrated in FIG. 9D and FIG. 9E.

In some embodiments, application implementation instructions 1014 is a software module that includes a set of one or more computer-readable instructions. In some embodiments, the set of one or more instructions of instructions 1014 correspond to one or more operations performed by application 1012. For example, when application 1012 is a messaging application, application implementation instructions 1014 can include operations to receive and send messages. In some embodiments, application implementation instructions 1014 communicates with API calling instructions to communicate with system 1022 via API 1018 (shown in FIG. 9E).

In some embodiments, API-calling instructions 1016 is a software module that includes a set of one or more computer-executable instructions.

In some embodiments, implementation instructions 1020 is a software module that includes a set of one or more computer-executable instructions.

In some embodiments, API 1018 is a software module that includes a set of one or more computer-executable instructions. In some embodiments, API 1018 provides an interface that allows a different set of instructions (e.g., API calling instructions 1016) to access and/or use one or more functions, methods, procedures, data structures, classes, and/or other services provided by implementation instructions 1020 of system 1022. For example, API-calling instructions 1016 can access a feature of implementation instructions 1020 through one or more API calls or invocations (e.g., embodied by a function or a method call) exposed by API 1018 and can pass data and/or control information using one or more parameters via the API calls or invocations. In some embodiments, API 1018 allows application 1012 to use a service provided by a Software Development Kit (SDK) library. In some embodiments, application 1012 incorporates a call to a function or method provided by the SDK library and provided by API 1018 or uses data types or objects defined in the SDK library and provided by API 1018. In some embodiments, API-calling instructions 1016 makes an API call via API 1018 to access and use a feature of implementation instructions 1020 that is specified by API 1018. In such embodiments, implementation instructions 1020 can return a value via API 1018 to API-calling instructions 1016 in response to the API call. The value can report to application 1012 the capabilities or state of a hardware component of device 1010, including those related to aspects such as input capabilities and state, output capabilities and state, processing capability, power state, storage capacity and state, and/or communications capability. In some embodiments, API 1018 is implemented in part by firmware, microcode, or other low level logic that executes in part on the hardware component.

In some embodiments, API 1018 allows a developer of API-calling instructions 1016 (which can be a third-party developer) to leverage a feature provided by implementation instructions 1020. In such embodiments, there can be one or more set of API-calling instructions (e.g., including API-calling instructions 1016) that communicate with implementation instructions 1020. In some embodiments, API 1018 allows multiple sets of API-calling instructions written in different programming languages to communicate with implementation instructions 1020 (e.g., API 1018 can include features for translating calls and returns between implementation instructions 1020 and API-calling instructions 1016) while API 1018 is implemented in terms of a specific programming language. In some embodiments, API-calling instructions 1016 calls APIs from different providers such as a set of APIs from an OS provider, another set of APIs from a plug-in provider, and/or another set of APIs from another provider (e.g., the provider of a software library) or creator of the another set of APIs.

Examples of API 1018 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 1010. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 1020 is a system (e.g., operating system, server system) software module (e.g., a collection of computer-readable instructions) that is constructed to perform an operation in response to receiving an API call via API 1018. In some embodiments, implementation instructions 1020 is constructed to provide an API response (via API 1018) as a result of processing an API call. By way of example, implementation instructions 1020 and API-calling instructions 1016 can each be any one of an operating system, a library, a device driver, an API, an application program, or other module. It should be understood that implementation instructions 1020 and API-calling instructions 1016 can be the same or different type of software module from each other. In some embodiments, implementation instructions 1020 is embodied at least in part in firmware, microcode, or other hardware logic.

In some embodiments, implementation instructions 1020 returns a value through API 1018 in response to an API call from API-calling instructions 1016. While API 1018 defines the syntax and result of an API call (e.g., how to invoke the API call and what the API call does), API 1018 might not reveal how implementation instructions 1020 accomplishes the function specified by the API call. Various API calls are transferred via the one or more application programming interfaces between API-calling instructions 1016 and implementation instructions 1020. Transferring the API calls can include issuing, initiating, invoking, calling, receiving, returning, and/or responding to the function calls or messages. In other words, transferring can describe actions by either of API-calling instructions 1016 or implementation instructions 1020. In some embodiments, a function call or other invocation of API 1018 sends and/or receives one or more parameters through a parameter list or other structure.

In some embodiments, implementation instructions 1020 provides more than one API, each providing a different view of or with different aspects of functionality implemented by implementation instructions 1020. For example, one API of implementation instructions 1020 can provide a first set of functions and can be exposed to third party developers, and another API of implementation instructions 1020 can be hidden (e.g., not exposed) and provide a subset of the first set of functions and also provide another set of functions, such as testing or debugging functions which are not in the first set of functions. In some embodiments, implementation instructions 1020 calls one or more other components via an underlying API and thus be both an set of API calling instructions and a set of implementation instructions. It should be recognized that implementation instructions 1020 can include additional functions, methods, classes, data structures, and/or other features that are not specified through API 1018 and are not available to API calling instructions 1016. It should also be recognized that API calling instructions 1016 can be on the same system as implementation instructions 1020 or can be located remotely and access implementation instructions 1020 using API 1018 over a network. In some embodiments, implementation instructions 1020, API 1018, and/or API-calling instructions 1016 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 700 (FIG. 7) and/or process 800 (FIG. 8) is performed at a first computer system (as described herein) via a system process (e.g., an operating system process, a server system process) that is different from one or more applications executing and/or installed on the first computer system.

In some embodiments, process 700 (FIG. 7) and/or process 800 (FIG. 8) is performed at a first computer system (as described herein) by an application that is different from a system process. In some embodiments, the instructions of the application, when executed, control the first computer system to perform process 700 (FIG. 7) and/or process 800 (FIG. 8) by calling an application programming interface (API) provided by the system process. In some embodiments, the application performs at least a portion of process 700 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 700 (FIG. 7) and/or process 800 (FIG. 8) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the first computer system to perform process 700 (FIG. 7) and/or process 800 (FIG. 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the API 1018 defines a first API call that can be provided by API calling instructions 1016, wherein the definition for the first API call specifies the following call parameters: audio data.

In some embodiments, the API 1018 defines a first API call response that can be provided to the application by API calling instructions 1016, wherein the first API call response includes text data (e.g., a transcript and/or summary) generated based on the audio data.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 1010) that runs the application. In some embodiments, the set of implementation instructions is included in an electronic device that is separate from the device that runs the application.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
establishing, by a first electronic device, a communication session with a second electronic device;
receiving, by the first electronic device, a request to record the communication session with the second electronic device;
providing, by the first electronic device and responsive to the request, a notification to the second electronic device that the communication session will be recorded;
prior to recording the communication session, verifying that only the first and second electronic devices are participating in the communication session; and
after providing the notification, recording, by the first electronic device, the communication session.

2. The method of claim 1, further comprising:
detecting that a third electronic device has joined the communication session; and
responsive to the detecting, stopping the recording of the communication session.

3. The method of claim 1, wherein the communication session comprises an audio communication session.

4. The method of claim 3, wherein providing the notification comprises:
when audio input on the first electronic device is muted:
unmuting, by the first electronic device, the audio input on the first electronic device; and
streaming an audio notification through the communication session.

5. The method of claim 3, wherein unmuting the audio input on the first electronic device is performed below an application layer while a microphone of the first electronic device is muted at the application layer according to a mute graphical element on a user interface corresponding to the communication session.

6. The method of claim 3, wherein the communication session further comprises an audio and video communication session.

7. The method of claim 1, further comprising:
prior to recording the communication session, receiving, by the first electronic device and from the second electronic device, an indication of consent to the recording.

8. The method of claim 1, further comprising:
while recording the communication session:
generating, by the first electronic device, a transcript of the communication session.

9. The method of claim 8, wherein the communication session is facilitated by a first application of the first electronic device and further comprising:
generating, by a machine learning model on the first electronic device, a summary of the transcript; and
storing the recording and the summary in association with a second application of the first electronic device, the second application being separate from the first application.

10. An electronic device comprising:
a memory; and
a processor circuit configured to:
establish, by the electronic device, a communication session with another electronic device;
receive, by the electronic device, a request to record the communication session with the other electronic device;
provide, by the electronic device and responsive to the request, a notification to the other electronic device that the communication session will be recorded;
prior to recording the communication session, verify that only the electronic device and the other electronic device are participating in the communication session; and
after providing the notification, record, by the electronic device, the communication session.

11. The electronic device of claim 10, wherein the processor circuit is further configured to:
detect that a third electronic device has joined the communication session; and
responsive to the detecting, stop the recording of the communication session.

12. The electronic device of claim 10, wherein the communication session comprises an audio communication session.

13. The electronic device of claim 12, wherein providing the notification comprises:
when audio input on the electronic device is muted:
unmuting, by the electronic device, the audio input on the electronic device; and
streaming an audio notification through the communication session.

14. The electronic device of claim 12, wherein unmuting the audio input on the electronic device is performed below an application layer while a microphone of the electronic device is muteable at the application layer according to a mute graphical element on a user interface corresponding to the communication session.

15. The electronic device of claim 12, wherein the communication session further comprises an audio and video communication session.

16. The electronic device of claim 10, wherein the processor circuit is further configured to:
prior to recording the communication session, receiving, by the electronic device and from the other electronic device, an indication of consent to the recording.

17. The electronic device of claim 10, wherein the processor circuit is further configured to:
while recording the communication session:
generate, by the electronic device, a transcript of the communication session.

18. The electronic device of claim 17, wherein the communication session is facilitated by a first application of the electronic device and wherein the processor circuit is further configured to:
generate, by a machine learning model on the electronic device, a summary of the transcript; and
store the recording and the summary in association with a second application of the electronic device, the second application being separate from the first application.

19. A non-transitory computer-readable medium storing instructions that, when executed by a processor of a first electronic device, causes the processor to perform operations comprising:
establishing, by a first electronic device, a communication session with a second electronic device;
receiving, by the first electronic device, a request to record the communication session with the second electronic device;
providing, by the first electronic device and responsive to the request, a notification to the second electronic device that the communication session will be recorded;
prior to recording the communication session, verifying that only the first and second electronic devices are participating in the communication session; and
after providing the notification, recording, by the first electronic device, the communication session.

20. The non-transitory computer-readable medium of claim 19, wherein the instructions cause the processor to perform operations further comprising:
detecting that a third electronic device has joined the communication session; and
responsive to the detecting, stopping the recording of the communication session.

21. A computer-readable medium storing instructions of an application for controlling a first electronic device to perform a method, the method comprising:
obtaining first information based on user input corresponding to a request to record a communication session, wherein the communication session includes the first electronic device and a second electronic device separate from the first electronic device;
providing the first information based on user input to an operating system of the first electronic device; and
in response to providing the first information to the operating system, receiving second information, wherein the second information includes a recording of the communication session, wherein the first information causes the operating system to verify that only the first and second electronic devices are participating in the communication session, provide a notification to the second electronic device that the communication session will be recorded, and record the communication session.

22. A computer-readable medium storing instructions of an application for controlling a first electronic device to perform a method, the method comprising:
in response to providing first information to an operating system, obtaining second information, wherein the second information includes a recording of a communication session between first and second electronic devices, wherein the first information causes the operating system to verify that only the first and second electronic devices are participating in the communication session, provide a notification to the second electronic device that the communication session will be recorded, and record the communication session; and
performing an operation with the second information, wherein the operation comprises obtaining a transcription of the recording.
